(19) United States
(12) Patent Application Publication
(10) Pub. No.: US 2008/0246841 A1
(43) Pub. Date: Oct. 9, 2008

(54) Method and system for automatically generating personalized media collection for participants

(76) Inventors: Taiming Chen, Los Gatos, CA (US); Tzu-Hsin Yang, Los Gatos, CA (US)

Correspondence Address: TAIMING CHEN, 150 FOREST HILL DR., LOS GATOS, CA, 95032, US

(21) Appl. No.: 11/789,492

(22) Filed: Apr. 26, 2007

Related U.S. Application Data
(60) Provisional application No. 60/921,396, filed on Apr. 3, 2007.

(51) Int. Cl. H04N 7/18

(52) U.S. Cl. 348/143; 348/E07.085

(57) ABSTRACT

The present systems and methods disclose a system for automatically generating personalized media collection for participants. The invention continually captures media from area of activities by using at least one camera station. Camera station sends captured media data alone with time and capture zoning information to networked computer storage. At least one participant wears a use mobile device and move freely around the area. The Said mobile device logs participant's location and time information, trail log, while wore by participant and later uploads its content to client computer for processing. Client computer finds and gathers media clips with participant's presence from captured media and then edit all gathered media clips into a personalized media collection for participant.

### CROSS-REFERENCE TO RELATED APPLICATIONS

This application is related to and claims priority from U.S. Provisional Patent Application Serial No. 60/921,396 filed on Apr. 3, 2007

### FIELD OF THE INVENTION

The present invention relates generally to the field of media capturing and editing, in particular to a system and method for automatically gathering media clips associate to a participant from a media database by using participant's spatial and temporal log and generate a media collection for participant. Where said media database is captured and stored with time and capture zoning information by at least one camera station at area of activity where participant was within.

### BACKGROUND OF THE INVENTION

Security camera or surveillance system records and stores its recording so that it can be retrieved later for viewing. Technologies also allow additional information such as time, camera name and direction of pointing of a camera . . . etc, to be stored with media itself. Such a system is already commonly applied for many public places. Many of them utilize latest network and storage technologies and keep the recorded data at a central storage database for easy accessing.

People like to take souvenir picture shot or video recording to memorize their special activity. Video recording or pictures contain themselves is highly desired for reasons from improve oneself in performing sport to just to refresh memory.

Currently, either a tripods or another person can take a camera to perform such a task However, burden free automated system is more desirable due to convenience and more complete coverage (no one in a group need to control the camera).

### BRIEF SUMMARY OF THE INVENTION

The present invention seeks to provide automated media capturing/editing systems and methods which can be used to provide souvenir video service for public at entertainment park or sport park.

Media is captured by camera stations around area of activities and stored with time stamps and capture zoning information to a media database on server. Capture zoning information that store with captured media can be in a form of merely a camera's identification; capture zoning information can be related from this identification by referring to a separate set of geographic coordinates associate to this camera identification.

A user mobile device periodically logs its location information from its built-in GPS receiver and time stamp from its built-in clock.

Participants each wear said user mobile devices to move freely within area of activities. Each mobile device periodically logs its positioning and time information, the trail log, into mobile device's on board memory for later uploading or wirelessly sends to network storage.

When a participant finished a day's activities in area and turn in the mobile device, the trail log gets uploaded to a client computer.

Client computer calculates participant's presence in media by matching spatial and temporal information between said media database and participant's trail log. Client computer then retrieves part of media, media clip, with participant's presence from said media database.

Once client computer gathered enough media clips with participant's presence, client computer can generate a personalized media collection which filled with media clips of participant's presence and make a carry able copy for participant to keep.

### BRIEF DESCRIPTION OF THE DRAWINGS

FIG. 1 illustrates one implementation of the embodiments of the invention used in conjunction with a participant that is a skier at ski range where camera stations and networked computers are equipped.

FIG. 2 illustrates additional details of one implementation of the camera station in accordance with the embodiments of the invention.

FIG. 3 illustrates additional details of one implementation of the camera station in accordance with the embodiments of the invention.

FIG. 4 illustrates additional details of one implementation of the participant's mobile device in accordance with the embodiments of the invention.

FIG. 5 illustrates additional details of one implementation of the media editing in accordance with the embodiments of the invention.

FIG. 6 illustrates an architectural view of an embodiment of the invention for generating personalized media collection for participants.

FIG. 7 illustrates additional details of one implementation of the editing on media recorded by camera stations in accordance with the embodiments of the invention.

FIG. 8 illustrates additional details of one implementation of the camera station's view on participant in accordance with the embodiments of the invention.

### DETAILED DESCRIPTION OF THE PREFERRED EMBODIMENT

Prior to proceeding to the more detailed description of the present invention, it should be noted that, for the sake of clarity and understanding, identical components which have identical functions have been identified with identical reference numerals throughout the several views illustrated in the drawing figures.

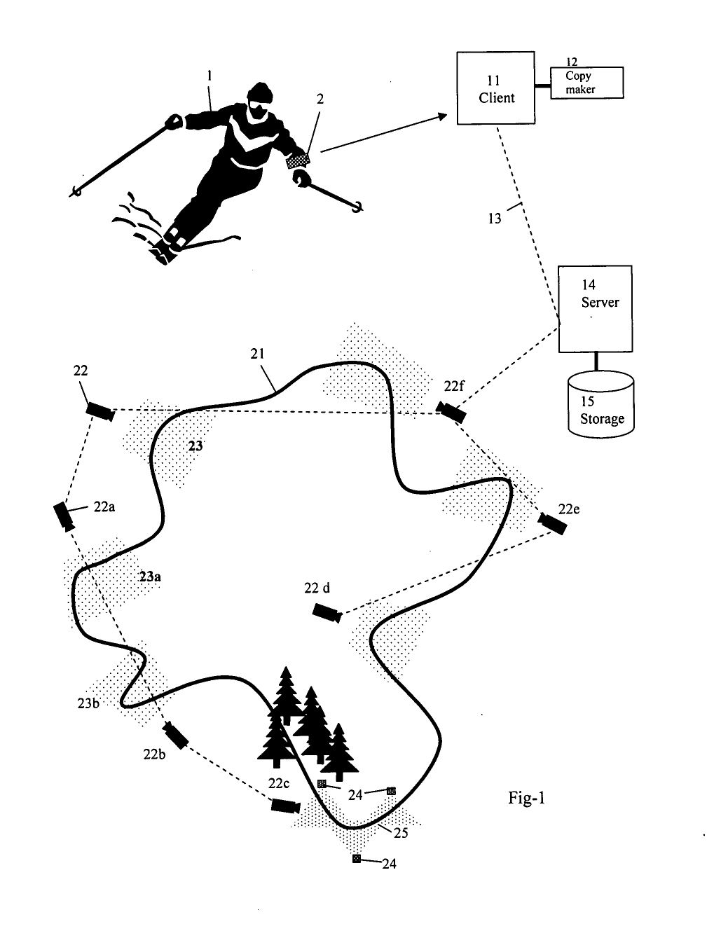

With reference now to the figures and in particular with reference now to FIG. 1, a diagram illustrating the invented system. In this illustrative example, a user mobile device 2 is wore by a participant 1, a skier, who is traveling on a ski range course 21. Said mobile device 2, when wore by participant, continually logs its position and time information to keep participant's trail log for future uploading into client computer 11. There are camera stations 22, 22a, 22b, 22c, 22d, 22e, 22f mount around the ski course 21. The capturing zone for camera station 22 is zone 23; capturing zone for camera station 22a is zone 23a; capturing zone for camera station 22b is zone 23b, capturing zone for camera station 22c is zone 25. The images and sound captured by camera stations are sent to network server 14 and store in a database on storage 15 via network 13.

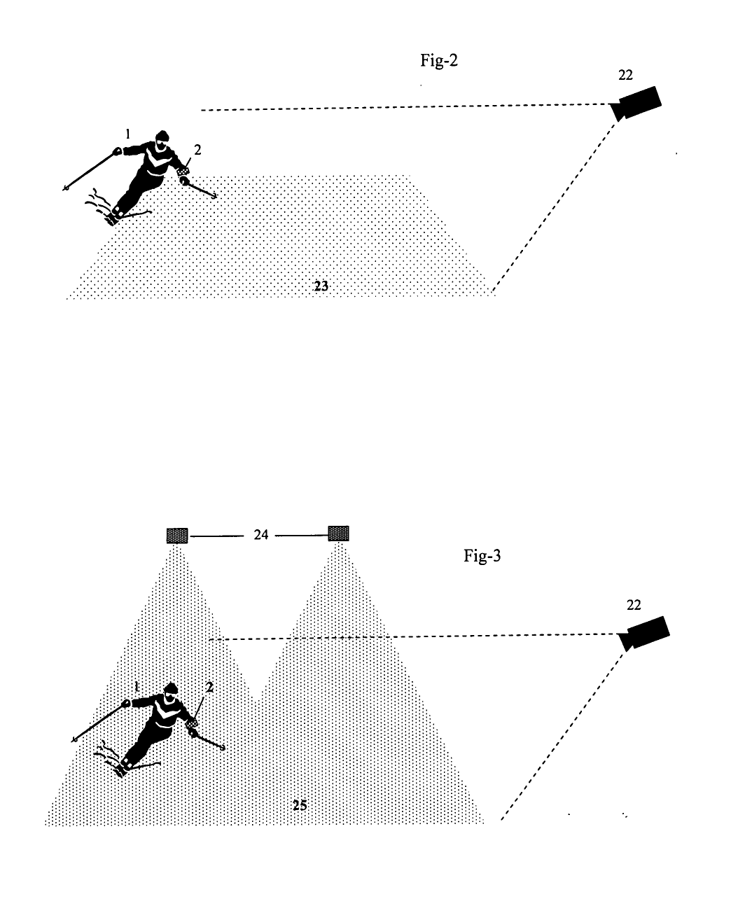

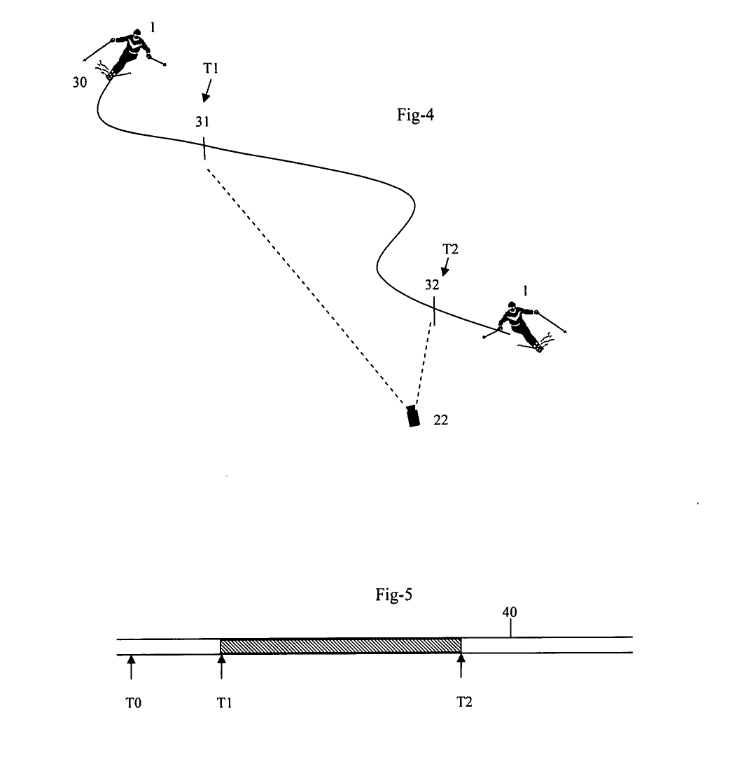

Once participant 1 finished his/her activities, participant 1 turns in his/her mobile device 2 to a client computer 11 for trail log uploading. Base on a participant's trail log, a client computer can search and pick out clips with participant's presence in said media database from all camera stations base on spatial and temporal matching; more detail information about this matching are given in FIG. 2, FIG. 3, FIG. 4 and FIG. 5 and explained later.

Media clips with participant's presence then are gathered and edited into a collective media by client computer 11 and made into a copy at media copy maker 12.

Spatial matching maybe performed by checking a mobile device's GPS location as explained in FIG. 2 or by checking if a coded transmission from camera station is received by a mobile device as explained in FIG. 3.

FIG. 2 shows a participant 1 is within a camera capturing zone 23 of camera station 22, where the capturing zone is define by enclosure of geographical coordinates. Participant is considered within a capturing zone 23 if his/her user mobile device log a GPS position that's within the zone's defined territory 23.

FIG. 3 shows a participant 1 is within a capturing zone 25 of camera station 22c, where the capturing zone is illuminated by transmission sources 24 which emit a coded transmission with camera station's ID code. The transmission maybe invisible and inaudible so it won't affect media recording yet still can be recognized by sensor of user mobile device 2. Infrared or ultrasound can be used for such an implementation, the transmission can only illuminate a mobile device effectively if within a certain distance. Participant 1 is considered within capturing zone 25 if his/her user mobile device 2 received such a transmission and a positive ID code is decoded.

FIG. 4 shows a participant 1 travel on course 21. Participant 1 was at location 31 at time T1 and at location 32 at time T2. Camera station 22 can cover course spatially from location 31 to 32 and store its recording to media 40 as described in FIG. 5.

FIG. 5 shows time line of media 40 that's captured by camera station 22 as described in FIG. 4. The shaded area is time marked from time T1 to time T2 and can be considered a media clip with participant's 1 presence.

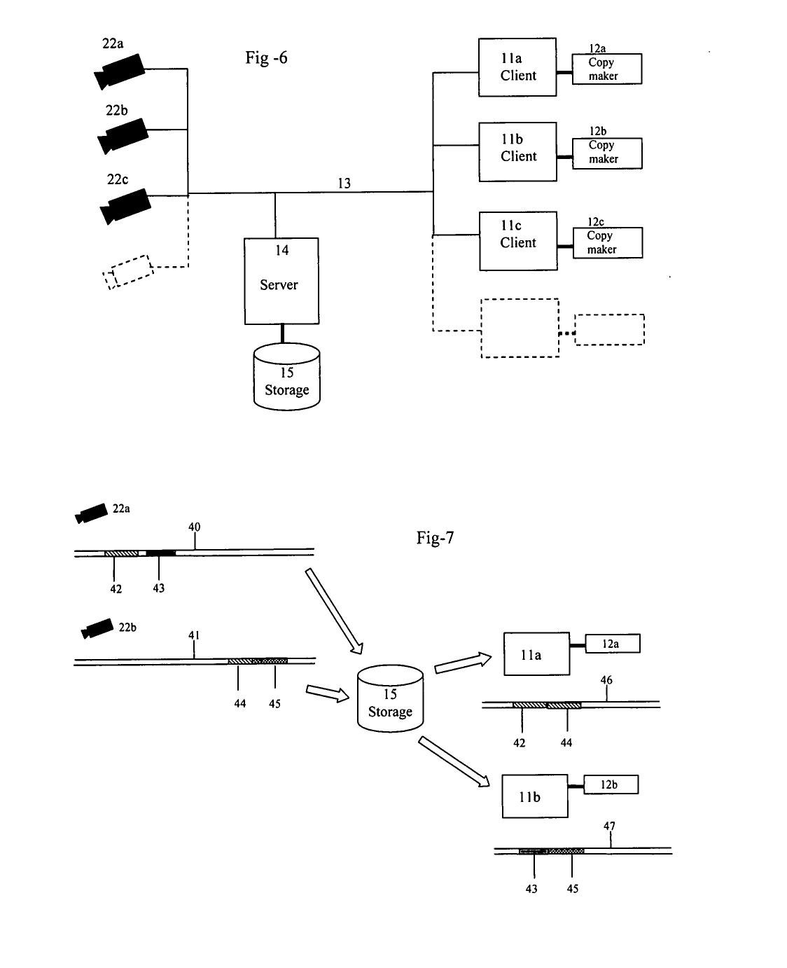

FIG. 6 shows a system configuration. Camera 22a, 22b, and 22c are connected to network 13. Storage 15 is connected to server 14 and then connects to network 13 as well. Client 11a, 11b, and 11c are connecting to network 13. They each have a copy maker 12a, 12b and 12c.

FIG. 7 shows two camera stations 22a and 22b are both capturing and recording. Camera station 22a stores its capture into media 40 which is part of said database; camera station 22b stores its capture into media 41, which is also part of said database. A first participant was captured by camera station 22a and can be found at media clip 42; later the same first participant was captured by camera station 22b and can be found at media clip 44. Another second participant was captured by camera station 22a and can be found at media clip 43; later the same second participant was captured by camera station 22b and can be found at media clip 45. Client computer 11a is used to make media collection 46 for first participant; both media clips 42 and 44 from both cameras are used. Client computer 11b is used to make media collection 47 for second participant; both media clips 43 and 45 from both cameras are used.

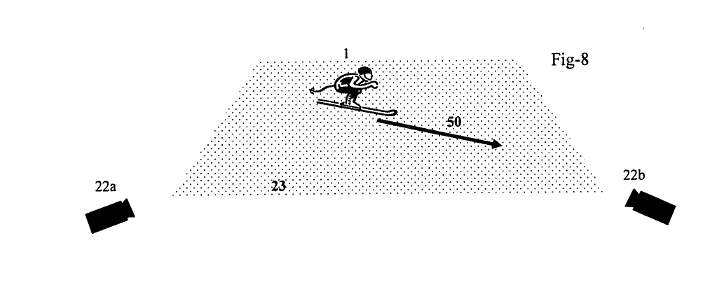

FIG. 8 shows two camera station 22a and 22b have overlapped capturing zone 23. Participant 1 is traveling in this zone 23 following the direction of arrow 50. When calculating participant's 1 presence, client computer will find participant's presence in both media clips. With further referring to travel direction found in participant's trail log, client computer can decide media clip from camera station 22b has more frontal view than clip from camera station 22a.

I claim:

1, A system for automatically capturing and gathering media collection for participants comprising of: networked computers and storages; At least one networked camera station captures media(video/still image/audio) data and store it with time and capture zoning information into a media database on said storage; at least one user wearable mobile device that continually logs participant's position and time information as a trail log, for later uploading to a networked client computer; At least one said networked client computer that can access said trail log from said mobile device and said stored media database from server storage.

2, The system of claim 1, where at least one media copy maker that is accessible by said computers and is able to make carry able media copy for participant to keep.

3, The system of claim 1, where each said camera station, computer and user mobile device contains an accurate computer clock that is able to sync up with each other to keep the same time within a permitted error range.

4, The system of claim 1, where the said user mobile device detects its location from a built-in GPS, Global Positioning System, receiver.

5, The system of claim 1, where the said user mobile device has a build-in micro-phone to record user's voice.

6, The system of claim 1, where the said user mobile device can wirelessly send its content to network storage instead of keep it at on board memory.

7, The system of claim 1, where the said camera station knows its capturing zone information base on its own location, angle of view pointing and zooming factor, and sends the capturing zone information along with media to server for storage.

8, The system of claim 1, where the said camera station may emit invisible/inaudible identification coded transmission to mark its capturing zone; And the said mobile device can detect and decode the coded transmission when within proximity so it can log its position as within capturing zone of identified camera.

9, The system of claim 1, where the said networked camera station records only when its sensor detects object is within or is approaching to its capturing zone.

10, The system of claim 1, further comprising pre-recorded media clips stored in said media database for client computer to access.

11, A method for automatically generating media collection for participants comprising the steps of:
continually capturing media and store it with time and capture zoning information into a database;
logging each participant's trail by recording location and time information with a user mobile device;
uploading said participant trail log onto a client computer; calculating participant's presence in media by matching spatial and temporal information between stored media database from each camera station and participant's trail log;
automatically gathering media clips with participant's presence and make a personalized media collection for participant.

12, The method of claim 11, further comprising adding pre-recorded media clips into said personalized media collection base on user's interest level revealed from participant's location stayed and time spent.

13, The method of claim 11, wherein said client computer may assign scores to said media clips base on possible appearance size calculated from distance to camera and camera zooming factor; client computer then generates media collection sourcing from media clips base on their scores.

14, The method of claim 11, wherein said client computer may use participant's trail log to decide participant's direction of movement and decide if a camera station has more or less frontal view on a participant, further assigning score numbers to media clips from different camera stations; client computer then generates media collection base on media clip's scores.
